(19) United States
(12) Patent Application Publication
(10) Pub. No.: US 2016/0158960 A1
(43) Pub. Date: Jun. 9, 2016

(54) IRON-CORROSION INHIBITION METHOD, AND WOOD TREATMENT METHOD

(71) Applicant: KATAYAMA CHEMICAL INC., Osaka (JP)

(72) Inventor: Kenta MATSUMURA, Osaka-shi, Osaka (JP)

(21) Appl. No.: 14/906,179

(22) PCT Filed: Jul. 17, 2014
(86) PCT No.: PCT/JP2014/068977

§ 371 Date: Jan. 19, 2016

(30) Foreign Application Priority Data
Jul. 19, 2013 (JP) 2013-150778
Sep. 11, 2013 (JP) 2013-188262

(51) Int. Cl. B27K 5/04; C09D 5/08

(52) U.S. Cl. CPC B27K 5/04; C09D 5/086

(57) ABSTRACT

The present disclosure provides a drug composition capable of preventing corrosion of components or the like made of iron that may come into contact with the drug composition in a wood treatment device for impregnating wood with a drug composition, and a method for preventing corrosion of the components or the like made of iron. In one or more embodiments, the present disclosure relates to a method for preventing corrosion of iron in a wood treatment device, including impregnating wood with a drug composition using the wood treatment device. The treatment device has a component or a portion made of iron that comes into contact with the drug composition, and the drug composition is an aqueous solution composition containing an iodopropynyl carbamate compound and an organic acid salt of quaternary ammonium.

### TECHNICAL FIELD

The present disclosure relates to a method for preventing corrosion of iron in a wood pressure treatment device, and a method for treating wood.

### BACKGROUND ART

Patent Document 1 discloses an aqueous wood-preservative and antitermite composition composed of an aqueous solution including: (A) at least one active ingredient selected from cyproconazole, IPBC, and imidacloprid; and (B) at least another active ingredient selected from an inorganic or organic acid salt of dodecylamine, an inorganic or organic acid salt of tetradecylamine, and an organic acid salt of N, N-didecyl-N-methyl-poly(oxyethyl) ammonium.

Patent Document 2 discloses a wood preservative composition including IPBC and a specific amine oxide. Patent Document 2 further discloses that a mixture of IPBC and water is corrosive to carbon steel (paragraphs [0058] and [0059]).

Patent Document 3 discloses that a wood antisapstain composition containing IPBC corrodes processing equipment or a dipping tank for dipping wood, and reactive metal ions leached out by corrosion inactivate IPBC (paragraph [0003]).

Patent Document 4 discloses a disinfectant containing an organic carboxylate of quaternary ammonium having two alkyl groups with 8 to 12 carbons and having an oxyethylene group.

### PRIOR ART DOCUMENTS

### Patent Documents

Patent Document 1: JP 2010-173969 A

Patent Document 2: JP 2003-500372 A

Patent Document 3: JP 2011-522786 A

Patent Document 4: JP 1984(559)-227842 A

### DISCLOSURE OF INVENTION

### Problem to be Solved by the Invention

The present disclosure provides a drug composition capable of preventing corrosion of components or the like made of iron that may come into contact with the drug composition in a wood treatment device for impregnating wood with a drug composition, and a method for preventing corrosion of the components or the like made of iron.

### Means for Solving Problem

In one or more embodiments, the present disclosure relates to a method for preventing corrosion of iron in a wood treatment device, including impregnating wood with a drug composition using the treatment device. The treatment device has a component or a portion made of iron that comes into contact with the drug composition, and the drug composition is an aqueous solution composition containing an iodopropynyl carbamate compound and an organic acid salt of quaternary ammonium.

In one or more embodiments, the present disclosure further relates to a method for treating wood with a pressure treatment device including a pressure-resistant pressure vessel and a pressurizing pump for injecting by pressure a drug composition into wood in the pressure vessel, the method including bringing the drug composition injected by pressure into contact with wood in the pressure vessel. The pressure vessel has a component or a portion made of iron that comes into contact with the drug composition, and the drug composition is an aqueous solution composition containing an iodopropynyl carbamate compound and an organic acid salt of quaternary ammonium.

### Effect of the Invention

In one or more embodiments, the present disclosure can prevent corrosion of components or the like made of iron that may come into contact with a drug composition in a wood treatment device for impregnating wood with a drug composition.

### BRIEF DESCRIPTION OF DRAWINGS

FIG. 1 show photographs of test pieces after corrosion test of Comparative Example 1, Reference Example 1, and Examples 1 and 2. The photographs on the left show states before rust removal cleaning, and those on the right show states after rust removal cleaning.

FIG. 2 shows photographs of test pieces after corrosion test of Comparative Examples 2 and 3, Reference Examples 2 and 3, and Example 3. The photographs on the left show states before rust removal cleaning, and those on the right show states after rust removal cleaning.

FIG. 3 shows photographs of test pieces after corrosion test of Comparative Example 4, Reference Examples 4 and 5, and Examples 4 and 5. The photographs on the left show states before rust removal cleaning, and those on the right show states after rust removal cleaning.

### DESCRIPTION OF THE INVENTION

An iodopropynyl carbamate compound typified by IPBC alone is corrosive material to iron (Patent Documents 2 and 3). However, when combined with an organic acid salt of quaternary ammonium, the iodopropynyl carbamate compound exhibits iron corrosion resistance higher than those of the organic acid salt of quaternary ammonium alone. The present disclosure is based on the finding that the combination of the organic acid salt of quaternary ammonium and the iodopropynyl carbamate compound produces a synergistic effect in iron corrosion resistance.

In one aspect, the present disclosure relates to a method for preventing corrosion of iron in a wood treatment device (hereinafter, also referred to as an “corrosion prevention method according to the present disclosure”), including impregnating wood with a drug composition using a wood treatment device. The treatment device has a component or a portion made of iron that comes into contact with the drug composition, and the drug composition is an aqueous solution composition containing an iodopropynyl carbamate compound and an organic acid salt of quaternary ammonium.

[Iodopropynyl Carbamate Compound]

The drug composition used in the corrosion prevention method according to the present disclosure contains an iodopropynyl carbamate compound. In one or more embodiments, the iodopropynyl carbamate compound synergistically improves an iron anticorrosive effect in the presence of an organic acid salt of quaternary ammonium.

In one or more embodiments, the iodopropynyl carbamate compound may be, e.g., a compound expressed by the following general formula (I) from the viewpoint of improving the iron anticorrosive effect:

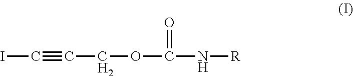

(where, in the general formula (I), R is selected from the group consisting of hydrogen, substituted and unsubstituted alkyl groups with 1 to 20 carbons, substituted and unsubstituted aryl, alkylaryl and aralkyl groups with 6 to 20 carbons, and substituted and unsubstituted cycloalkyl and cycloalkenyl groups with 3 to 10 carbons).

In one or more embodiments, in the general formula (I), R is selected from the group consisting of hydrogen, substituted and unsubstituted alkyl groups with 1 to 6 carbons, substituted and unsubstituted aryl, alkylaryl and aralkyl groups with 6 to 12 carbons, and substituted and unsubstituted cycloalkyl and cydoalkenyl groups with 3 to 10 carbons.

In one or more embodiments, the compound expressed by the general formula (I) may be, e.g., 3-iodo-2-propynyl-n-butylcarbamate [IPBC] from the viewpoint of improving the iron anticorrosive effect.

[Addition Amount]

In one or more embodiments, the drug composition used in the corrosion prevention method according to the present disclosure is prepared by diluting a concentrate with water for use. In one or more embodiments, the content of the iodopropynyl carbamate compound in the drug composition at use or at dilution is 30 to 1000 mg/L, 50 to 500 mg/L, 70 to 300 mg/L, or 100 to 200 mg/L.

[Organic Acid Salt of Quaternary Ammonium]

The drug composition used in the corrosion prevention method according to the present disclosure contains an organic acid salt of quaternary ammonium. In one or more embodiments, the organic acid salt of quaternary ammonium synergistically improves the iron anticorrosive effect in the presence of the iodopropynyl carbamate compound.

In one or more embodiments, the organic acid salt of quaternary ammonium may be, e.g., a compound expressed by the following general formula (II) from the viewpoint of improving the iron anticorrosive effect:

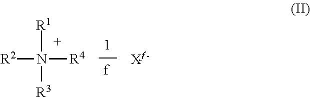

(where, in the general formula (II), R¹, R², and R³ represent the same or different alkyl groups with 1 to 24 carbons or alkenyl groups with 2 to 24 carbons; R⁴ is a polyoxyalkylene group with an average addition mole number of 1 to 20, an alkyl or alkenyl group with 6 to 24 carbons, or an arylalkyl or arylalkenyl group with 7 to 24 carbons; f is an integer of 1 to 10; and X^{f-} is an f-valent organic acid ion).

In the general formula (II), R¹, R², and R³ each represent a linear or branched alkyl group with 1 to 24 carbons, preferably 1 to 18 carbons, or a linear or branched alkenyl group with 2 to 24 carbons, preferably 2 to 18 carbons. In one or more embodiments, examples of the alkyl group include a methyl group, an ethyl group, a propyl group, a 2-ethylhexyl group, an octyl group, a lauryl group, a myristyl group, a cetyl group, and a stearyl group. In one or more embodiments, examples of the alkenyl group include an allyl group, a methallyl group, an octenyl group, a decenyl group, a dodecenyl group, a tetradecenyl group, a hexadecenyl group, and an oleyl group. R¹, R², and R³ may be the same or different from each other.

In one or more embodiments, when R⁴ is other than the polyoxyalkylene group with an average addition mole number of 1 to 20, preferable combinations of R¹, R², and R³ are a combination in which all of them have 1 to 2 carbons, especially are a methyl group, and a combination in which R¹ and R² have 1 to 2 carbons, especially are a methyl group, and R³ is an alkyl group with 8 to 18 carbons, especially 10 to 16 carbons.

In one or more embodiments, when R⁴ is a polyoxyalkylene group with an average addition mole number of 1 to 20, preferable combinations of R¹, R², and R³ are a combination in which R¹ is an alkyl group with 1 to 2 carbons, especially a methyl group, and R² and R³ are an alkyl group with 8 to 14 carbons.

R⁴ is a polyoxyalkylene group with an average addition mole number of 1 to 20, a linear or branched alkyl or alkenyl group with 6 to 24 carbons, or an arylalkyl or arylalkenyl group with 7 to 24 carbons. Examples of the polyoxyalkylene group include polyoxyethylene and polyoxypropylene groups. Example of the alkyl and alkenyl groups with 6 to 24 carbons include alkyl and alkenyl groups with 6 to 24 carbons among those described above.

Examples of the arylalkyl group with 7 to 24 carbons include a phenylalkyl group having an alkyl group with 1 to 6 carbons, such as a benzyl group, a phenylethyl group and a phenylbutyl group. Examples of the arylalkenyl group with 7 to 24 carbons include phenylethenyl and phenylpropenyl groups.

In one or more embodiments, R⁴ is preferably a polyoxyethylene with an average addition mole number of 1 to 20, alkyl, or arylalkyl group. When R⁴ is other than the polyoxyalkylene group with an average addition mole number of 1 to 20 and all of R¹ to R³ have 1 to 2 carbons, R⁴ is further preferably an alkyl group with 10 to 24 carbons. When R⁴ is other than the polyoxyalkylene group with an average addition mole number of 1 to 20, R¹ and R² have 1 to 2 carbons and R³ is an alkyl group with 8 to 18 carbons, R⁴ is preferably an alkyl or arylalkyl group with 8 to 18 carbons, particularly preferably a benzyl group.

In one or more embodiments, examples of the quaternary ammonium of the formula (II) include the following. In one or more embodiments, the organic acid salt of quaternary ammonium in the drug composition used in the corrosion prevention method according to the present disclosure may include plural kinds of quaternary ammoniums.

(1) Quaternary ammonium in which all of R¹ to R³ have 1 to 2 carbons, and R⁴ is an alkyl group with 10 to 24 carbons:

trimethyldodecyl ammonium, trimethyltetradecyl ammonium, trimethylhexadecyl ammonium, trimethyloctadecyl ammonium, trimethyl coconut oil alkyl ammonium, trimethyl-2-ethylhexyl ammonium, dimethylethyldodecyl ammonium, dimethylethyltetradecyl ammonium, dimethylethylhexadecyl ammonium, dimethylethyloctadecyl ammonium, dimethylethyl coconut oil alkyl ammonium, methyldiethyldodecyl ammonium, methyldiethyltetradecyl ammonium, methyldiethylhexadecyl ammonium, methyldiethyloctadecyl ammonium, methyldiethyl coconut oil alkyl ammonium, and methyldiethyl-2-ethylhexyl ammonium cation

(2) Quaternary ammonium in which R¹ and R² are an alkyl group with 1 to 2 carbons, R³ is an alkyl group with 8 to 18 carbons, and R⁴ is a benzyl group:

dimethyldecylbenzyl ammonium, dimethyldodecylbenzyl ammonium, dimethyltetradecylbenzyl ammonium, dimethylhexadecylbenzyl ammonium, and dimethyl coconut oil alkyl benzyl ammonium cation

(3) Quaternary ammonium in which R¹ and R² are an alkyl group with 1 to 2 carbons, and R³ and R⁴ are an alkyl group with 8 to 18 carbons:

dimethyldioctyl ammonium, dimethyloctyldecyl ammonium, dimethyldidecyl ammonium, dimethyldecyldodecyl ammonium, dimethyldidodecyl ammonium, dimethylditetradecyl ammonium, methylethyldidecyl ammonium, and diethyldidecyl ammonium cation
(4) Quaternary ammonium in which R¹ is an alkyl group with 1 to 2 carbons, R² and R³ are an alkyl group with 8 to 14 carbons, and R⁴ is a polyoxyethylene group:

N,N-didecyl-N-methyl-poly(oxyethyl) ammonium, N,N-didodecyl-N-methyl-poly(oxyethyl) ammonium, and N,N-ditetradecyl-N-methyl-poly(oxyethyl) ammonium In one or more embodiments, the average addition mole number of polyoxyethylene is 1 to 20, 1 to 10, or 1 to 5.

In one or more embodiments, the quaternary ammonium is preferably the above (3) or (4) from the viewpoint of improving the iron anticorrosive effect, and preferably the above (4) from the viewpoint of improving the iron anticorrosive effect and partial-corrosion inhibitive effect.

In one or more embodiments, examples of the organic acid salt includes salts of organic acids selected from oxalic acid, citric acid, malic acid, maleic acid, itaconic acid, tartaric acid, glutaric acid, adipic acid, pimelic acid, succinic acid, malonic acid, fumaric acid, phthalic acid, isophthalic acid, terephthalic acid, sebacic acid, azelaic acid, formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexane acid, 2-ethylhexane acid, n-octanoic acid, nonanoic acid, dodecanoic acid, tetradecanoic acid, stearic acid, oleic acid, benzoic acid, ethylbenzoic acid, cinnamic acid, t-butylbenzoic acid, glycolic acid, butanetetracarboxylic acid, trimellitic acid, pyromellitic acid, salicylic acid, glyceric acid and lactic acid, from the viewpoint of improving the iron anticorrosive effect. In one or more embodiments, the organic acid salt of quaternary ammonium in the drug composition used in the corrosion prevention method according to the present disclosure may include plural kinds of organic acid salts.

In one or more embodiments, examples of ions forming the organic acid salt include ions in the form of carboxylic acid ions, phosphoric acid ions, sulfonic acid ions, sulfuric ester ions, and phosphoric ester ions.

Carboxylic acids forming carboxylic acid ions may be, e.g., monovalent or divalent to decavalent carboxylic acids. Examples of the monovalent carboxylic acid include: aliphatic monovalent carboxylic acid with 1 to 18 carbons such as formic acid, acetic acid, propionic acid, butyric acid, caprylic acid, 2-ethylhexane acid, nonanoic acid, dodecanoic acid, tetradecanoic acid, stearic acid, and oleic acid; and aromatic monovalent carboxylic acid with 7 to 18 carbons such as benzoic acid, ethylbenzoic acid, cinnamic acid, and t-butylbenzoic acid. Examples of the divalent carboxylic acid include: aliphatic divalent saturated carboxylic acid with 2 to 8 carbons such as oxalic acid, malonic acid, succinic acid, adipic acid, sebacic acid, and azelaic acid; aliphatic divalent unsaturated carboxylic acid with 4 to 18 carbons such as maleic acid and itaconic acid; and aromatic divalent carboxylic acid with 8 to 20 carbons such as phthalic acid, isophthalic acid, and terephthalic acid. Examples of the trivalent to decavalent carboxylic acids include aliphatic tetravalent carboxylic acid such as butanetetracarboxylic acid, and aromatic trivalent or tetravalent carboxylic acid such as trimellitic acid and pyromellitic acid.

In one or more embodiments, examples of the organic acid salt of quaternary ammonium used in the corrosion prevention method according to the present disclosure include monovalent and divalent carboxylates of trimethylhexadecyl ammonium, didecyldimethyl ammonium, dimethyldodecylbenzyl ammonium, dimethyltetradecylbenzyl ammonium, and N,N-didecyl-N-methyl-poly(oxyethyl) ammonium, from the viewpoint of improving the iron anticorrosive effect. In one or more embodiments, an example of the monovalent carboxylic acid is propionic acid, and an example of the divalent carboxylic acid is adipic acid from the viewpoint of improving the iron anticorrosive effect.

[Addition Amount]

In one or more embodiments, the drug composition used in the corrosion prevention method according to the present disclosure is prepared by diluting a concentrate with water for use. In one or more embodiments, the content of the organic acid salt of quaternary ammonium in the drug composition at use or at dilution is 400 to 14000 mg/L, 800 to 7000 mg/L, 1000 to 5000 mg/L, or 1000 to 3000 mg/L.

[Other Components]

In one or more embodiments, the drug composition used in the corrosion prevention method according to the present disclosure may contain a component expressed by the following general formula (III) as a drug having an antitermite effect for wood:

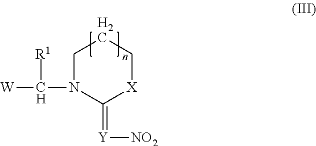

(where, in the general formula (III), X represents NH or S, Y represents CH or N, W represents a 2-chloro-5-pyridyl group or a 2-chloro-5-thiazolyl group, R¹ represents a hydrogen atom or a methyl group, and n represents 0 or 1).

In one or more embodiments, examples of the compound of the formula (III) include: 1-(6-chloro-3-pyridylmethyl)-2-nitromethylene-imidazolidine “imidacloprid”, 3-(6-chloro-3-pyridylmethyl)-2-nitromethylene-thiazolidine, 1-(6-chloro-3-pyridylmethyl)-2-nitroimino-imidazolidine, 1-(6-chloro-3-pyridylmethyl)-2-nitromethylene-tetrahydropyrimidine, and 3-(6-chloro-3-pyridylmethyl)-2-nitromethylene-tetrahydro-2H-1,3-thiazine, from the viewpoint of improving the antitermite effect.

[Addition Amount]

In one or more embodiments, the content of the compound of the formula (III) in the drug composition at use or at dilution is 10 to 1000 mg/L, 20 to 500 mg/L, or 40 to 100 mg/L.

In one or more embodiments, the drug composition used in the corrosion prevention method according to the present disclosure may contain a component expressed by the following general formula (IV) or (V) as a drug having a wood preservative effect:

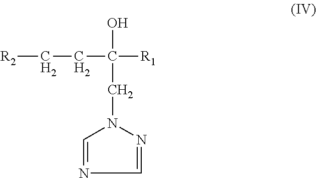

(where, in the general formula (IV), R₁ represents a branched or linear C₁ to C₅ alkyl group, and R₂ represents phenyl group, or in some cases substituted with halogen atom or one or more substituents selected from a halogen atom or C₁ to C₃ alkyl, and a C₁ to C₃ alkoxy, phenyl or nitro group, or in some cases), and

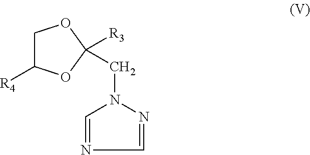

(where, in the general formula (V), R₃ is as defined for R₂ above, R₄ represents a hydrogen atom or a branched or liner C₁ to C₅ alkyl group).

In one or more embodiments, an example of the compound of the formula (IV) is tebuconazole: alpha-[2-(4-chlorophenyl)ethyl]-alpha(1,1-dimethylethyl)-1H-1,2,4-triazole-1-ethanol from the viewpoint of improving the preservative effect.

In one or more embodiments, examples of the compound of the formula (V) include propiconazole: 1-[[2-(2-4-dichlorophenyl)-4-propyl-1,3-dioxolane-2-yl]methyl]-1H-1,2,4-triazole), azaconazole: 1-[[(2,4-dichlorophenyl)-1,3-dioxolane-2-yl]methyl]-1H-1,2,4-triazole, and cyproconazole: (2RS, 3RS; 2RS, 3SR)-2-(4-chlorophenyl)-3-cyclopropyl-1-(1H-1,2,4-triazole-1-yl)butane-2-ol, from the viewpoint of improving the preservative effect.

[Addition Amount]

In one or more embodiments, the content of the compound of the formula (IV) or (V) in the drug composition at use or at dilution is 50 to 1000 mg/L, 70 to 500 mg/L, or 100 to 400 mg/L.

[Hydrophilic Organic Solvent]

In one or more embodiments, the drug composition used in the corrosion prevention method according to the present disclosure may further contain a hydrophilic organic solvent. In one or more embodiments, examples of the hydrophilic organic solvent include hydrophilic organic solvents selected from the group consisting of ethylene glycol, diethylene glycol, polyethylene glycol, diethylene glycol monomethyl ether, propylene glycol, butyl diglycol, butyl glycol, methylpropylene glycol, 2-butoxyethanol, diethylene glycol monobutyl ether, isobutanol, sec-butanol, 2-ethyl-1-butanol, isopentanol, 1-heptanol, 1-octanol, neopentyl alcohol, and combinations of two or more of these.

[Addition Amount]

In one or more embodiments, the content of the hydrophilic organic solvent in the drug composition at use or at dilution is 400 to 14000 mg/L, 800 to 7000 mg/L, or 1000 to 5000 mg/L.

In one or more embodiments, the drug composition used in the corrosion prevention method according to the present disclosure includes the iodopropynyl carbamate compound, the organic acid salt of quaternary ammonium, the compound of the formula (III), the compound of the formula (IV) or (V), the hydrophilic organic solvent, and water. In one or more other embodiments, the drug composition may further contain an antifoaming agent, a surfactant, and the like. In one or more embodiments, an example of the antifoaming agent is a silicon-based antifoaming agent. In one or more embodiments, an example of the surfactant is a higher alcohol-based and/or sorbitan-based surfactant. In particular, the higher alcohol-based surfactant may be, e.g., polyoxyalkylene alkyl ether, and the sorbitan-based surfactant may be, e.g., polyoxyethylene coconut oil fatty acid sorbitan, polyoxyethylene sorbitan monostearate, or polyoxyethylene sorbitan monooleate.

[Wood Treatment Method]

In one or more non-limiting embodiments, a wood treatment in the corrosion prevention method according to the present disclosure is a wood treatment by pressure injection. In one or more non-limiting embodiments, the wood treatment by pressure injection may be, e.g., a liquid pressure system in which a pressurizing pump injects by pressure a drug composition into a pressure vessel filled with a drug composition and wood, or an air pressure system in which wood after contact with a drug composition is arranged in a pressure vessel and then air inside the pressure vessel is pressurized. In one or more non-limiting embodiments, the wood treatment by pressure injection may be performed by an ordinary method using a pressure treatment device such as a vacuum pressure impregnation device. In one or more embodiments, the pressure treatment device includes a pressure-resistant pressure vessel and a pressurizing pump for injecting by pressure a drug composition into wood in the pressure vessel. Further, in one or more embodiments, the pressure treatment device includes a pressure-resistant pressure vessel, a liquid tank that can store a drug composition, and a pressurizing pump for injecting by pressure the drug composition in the liquid tank into the pressure vessel. The drug composition in the corrosion prevention method according to the present disclosure can reduce and/or inhibit corrosion of components or portions made of iron in the pressure treatment device that may come into contact with the drug composition.

Therefore, in another aspect, the present disclosure relates to a method for treating wood with a pressure treatment device including a pressure-resistant pressure vessel and a pressurizing pump for injecting by pressure a drug composition into wood in the pressure vessel, the method including bringing the drug composition injected by pressure into contact with wood in the pressure vessel. The pressure vessel has a component or a portion made of iron that comes into contact with the drug composition, and the drug composition is an aqueous solution composition containing an iodopropynyl carbamate compound and an organic acid salt of quaternary ammonium. In still another aspect, the present disclosure relates to a method for treating wood with a pressure treatment device including a pressure-resistant pressure vessel, a liquid tank that can store a drug composition, and a pressurizing pump for injecting by pressure the drug composition in the liquid tank into the pressure vessel, the method including bringing the drug composition injected by pressure into contact with wood in the pressure vessel. The pressure vessel has a component or a portion made of iron that comes into contact with the drug composition, and the drug composition is an aqueous solution composition containing an iodopropynyl carbamate compound and an organic acid salt of quaternary ammonium. The respective components in the drug composition in this aspect are as mentioned above.

[Preparation of Drug Composition]

In one or more embodiments, the drug composition used in the corrosion prevention method according to the present disclosure may be prepared by diluting a concentrate containing the respective components with water. The concentrate may be a concentrate of 10 to 300 times, 20 to 100 times, or 40 to 60 times. Alternatively, in one or more embodiments, the drug composition may be prepared by adding the respective components to water stored in the liquid tank of the treatment device so that the concentration becomes a specified level.

The present disclosure further relates to the following one or more embodiments.

[1] A method for preventing corrosion of iron in a wood treatment device, including impregnating wood with a drug composition using the treatment device,

wherein the treatment device has a component or a portion made of iron that comes into contact with the drug composition, and

the drug composition is an aqueous solution composition containing an iodopropynyl carbamate compound and an organic acid salt of quaternary ammonium.

[2] The method according to [1], wherein the treatment device is a pressure treatment device including a pressure-resistant pressure vessel and a pressurizing pump for injecting by pressure a drug composition into wood in the pressure vessel.
[3] The method according to [1] or [2], wherein the treatment device is a pressure treatment device including a pressure-resistant pressure vessel, a liquid tank that can store a drug composition, and a pressurizing pump for injecting by pressure the drug composition in the liquid tank into the pressure vessel.
[4] A method for treating wood with a pressure treatment device including a pressure-resistant pressure vessel and a pressurizing pump for injecting by pressure a drug composition into wood in the pressure vessel,

the method including bringing the drug composition injected by pressure into contact with wood in the pressure vessel,

wherein the pressure vessel has a component or a portion made of iron that comes into contact with the drug composition, and

the drug composition is an aqueous solution composition containing an iodopropynyl carbamate compound and an organic acid salt of quaternary ammonium.

[5] A method for treating wood with a pressure treatment device including a pressure-resistant pressure vessel, a liquid tank that can store a drug composition, and a pressurizing pump for injecting by pressure the drug composition in the liquid tank into the pressure vessel,

the method including bringing the drug composition injected by pressure into contact with wood in the pressure vessel,

wherein the pressure vessel has a component or a portion made of iron that comes into contact with the drug composition, and

the drug composition is an aqueous solution composition containing an iodopropynyl carbamate compound and an organic acid salt of quaternary ammonium.

[6] The method according to any one of [1] to [5], wherein the iodopropynyl carbamate compound is expressed by the following general formula (I):

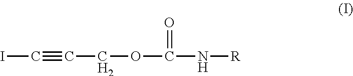

(where, in the general formula (I), R is selected from the group consisting of hydrogen, substituted and unsubstituted alkyl groups with 1 to 20 carbons, substituted and unsubstituted aryl, alkylaryl and aralkyl groups with 6 to 20 carbons, and substituted and unsubstituted cycloalkyl and cycloalkenyl groups with 3 to 10 carbons).

[7] The method according to any one of [1] to [6], wherein the iodopropynyl carbamate compound is 3-iodo-2-propynyl-n-butylcarbamate [IPBC].
[8] The method according to any one of [1] to [7], wherein the organic acid salt of quaternary ammonium is expressed by the following general formula (II):

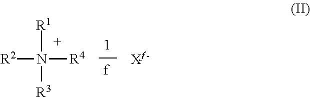

(where, in the general formula (II), R¹, R², and R³ represent the same or different alkyl groups with 1 to 24 carbons or alkenyl groups with 2 to 24 carbons; R⁴ is a polyoxyalkylene group with an average addition mole number of 1 to 20, an alkyl or alkenyl group with 6 to 24 carbons, or an arylalkyl or arylalkenyl group with 7 to 24 carbons; f is an integer of 1 to 10; and X^{f-} is an f-valent organic acid ion).

[9] The method according to any one of [1] to [8], wherein the quaternary ammonium is N,N-didecyl-N-methyl-poly(oxyethyl) ammonium.
[10] The method according to any one of [1] to [9], wherein the organic acid salt is a salt of an organic acid selected from oxalic acid, citric acid, malic acid, maleic acid, itaconic acid, tartaric acid, glutaric acid, adipic acid, pimelic acid, succinic acid, malonic acid, fumaric acid, phthalic acid, isophthalic acid, terephthalic acid, sebacic acid, azelaic acid, formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid?, 2-methylhexane acid, 2-ethylhexane acid, n-octanoic acid, nonanoic acid, dodecanoic acid, tetradecanoic acid, stearic acid, oleic acid, benzoic acid, ethylbenzoic acid, cinnamic acid, t-butylbenzoic acid, glycolic acid, butanetetracarboxylic acid, trimellitic acid, pyromellitic acid, salicylic acid, glyceric acid, and lactic acid.
[11] The method according to any one of [1] to [10], wherein the drug composition further contains at least one of α-(4-chlorophenyl)-α-(1-cyclopropyl-ethyl)-1H-1,2,4-triazole-1-ethanol “cyproconazole”, and 1-[(6-chloro-3-pyridinyl)-methyl]-4,5-dihydro-N-nitro-1H-imidazole-2-amine “imidacloprid”.
[12] The method according to any one of [1] to [11], wherein the drug composition further contains a hydrophilic organic solvent selected from the group consisting of ethylene glycol, diethylene glycol, polyethylene glycol, diethylene glycol monomethyl ether, propylene glycol, butyl diglycol, butyl glycol, methylpropylene glycol, 2-butoxyethanol, diethylene glycol monobutyl ether, isobutanol, sec-butanol, 2-ethyl-1-butanol, isopentanol, 1-heptanol, 1-octanol, neopentyl alcohol, and combinations of two or more of these.

Hereinafter, the present disclosure will be described based on the following examples. However, the present disclosure is not limited to these.

### Examples

### Preparation of Drug Composition

Drug reagents having the composition indicated in Table 1 below were prepared (Reference Examples 1-5, Examples 1-5, and Comparative Examples 1-4). First, concentrates were produced as in Table 1 and were all diluted 50 times with tap water, so as to prepare 1 L of respective drug reagents. The drug reagents of Comparative Examples 1, 2, and 4 were tap water. Abbreviations in Tables 1-4 stand for the following.

IPBC: 3-iodo-2-propynyl-n-butylcarbamate
DMPAP: N,N-didecyl-N-methyl-poly(oxyethyl) ammonium propionate (polymerization degree of EO group: 1 to 5, trade name: Bardap (registered trademark) 26, manufactured by Lonza Ltd., DMPAP content: 70%)
DDAA: N,N-didecyl-N,N-dimethylammonium adipate (trade name: OSMORIN DA-50, manufactured by Sanyo Chemical Industries, Ltd., DDAA content: 50%)
MDG: diethylene glycol monomethyl ether

TABLE 1

| | | | 50x dilution | | |
|---|---|---|---|---|---|
| | Concentrate | | by tap water | Test liquid (dilution) | |
| Reference Example 1 | DMPAP | 20% | → | DMPAP | 4000 ppm |
| Reference Examples 1-2 | DMPAP | 20% | → | DMPAP | 4000 ppm |
| | Cyproconazole | 0.60% | | Cyproconazole | 120 ppm |
| Example 1 | DMPAP | 20% | → | DMPAP | 4000 ppm |
| | IPBC | 1% | | IPBC | 200 ppm |
| | MDG | 15% | | MDG | 3000 ppm |
| | Imidacloprid | 0.30% | | Imidacloprid | 60 ppm |
| Example 2 | DMPAP | 20% | → | DMPAP | 4000 ppm |
| | IPBC | 1% | | IPBC | 200 ppm |
| | MDG | 15% | | MDG | 3000 ppm |
| | Imidacloprid | 0.30% | | Imidacloprid | 60 ppm |
| | Cyproconazole | 0.60% | | Cyproconazole | 120 ppm |
| Comparative Example 3 | MDG | 15% | → | MDG | 3000 ppm |
| Reference Example 2 | DMPAP | 10% | → | DMPAP | 2000 ppm |
| | MDG | 15% | | MDG | 3000 ppm |
| Reference Example 3 | DMPAP | 10% | → | DMPAP | 2000 ppm |
| | MDG | 15% | | MDG | 3000 ppm |
| | Imidacloprid | 0.30% | | Imidacloprid | 60 ppm |
| Example 3 | DMPAP | 10% | → | DMPAP | 2000 ppm |
| | IPBC | 1% | | IPBC | 200 ppm |
| | MDG | 15% | | MDG | 3000 ppm |
| Reference Example 4 | DMPAP | 10% | → | DMPAP | 2000 ppm |
| Example 4 | DMPAP | 10% | → | DMPAP | 2000 ppm |
| | IPBC | 0.50% | | IPBC | 100 ppm |
| Reference Example 5 | DDAA | 14% | → | DDAA | 2800 ppm |
| Example 5 | DDAA | 14% | → | DDAA | 2800 ppm |
| | IPBC | 0.50% | | IPBC | 100 ppm |

[Test Piece]

Low carbon steel SPCC-SB (1 mm×30 mm×50 mm; JISG3141) was used as a test piece for judging corrosiveness of iron.

[Corrosion Test]

A rotation method was adopted in the corrosion test. In the rotation method, a test piece was immersed in sample water and rotated at a constant speed. The corrosion state of the test piece after a given period was observed, and the anticorrosive effect was checked by calculating the corrosion speed. The corrosion speed was calculated by mass subtraction. The mass subtraction is a method for calculating from corrosion weight loss an average degree of corrosion during a test period (corrosion speed).

[Test Device]

A test device was used that includes: a shaft rod that can hold a test piece at its end; a three-one motor for rotating the shaft rod at a constant rotation speed; and a separable flask 1 L that can be heated by a silicon rubber heater that is connected to a thermoregulator for adjusting the temperature of test water.

[Test Condition]

The temperature of test water and the test period were 50° C. for 48 hours or room temperature for five days. The rotation speed of the test piece was 100 rpm.

[Evaluation]

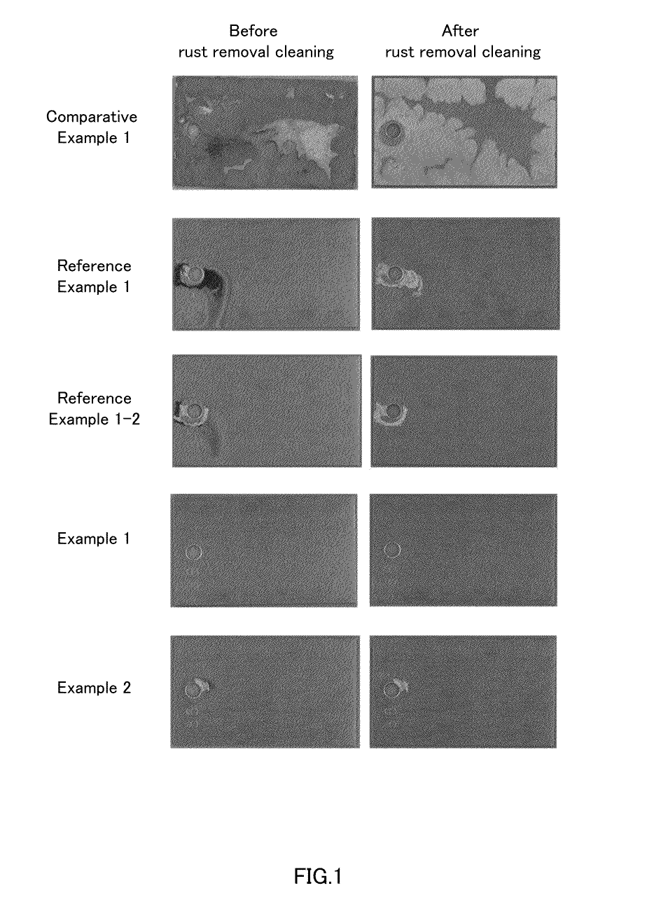

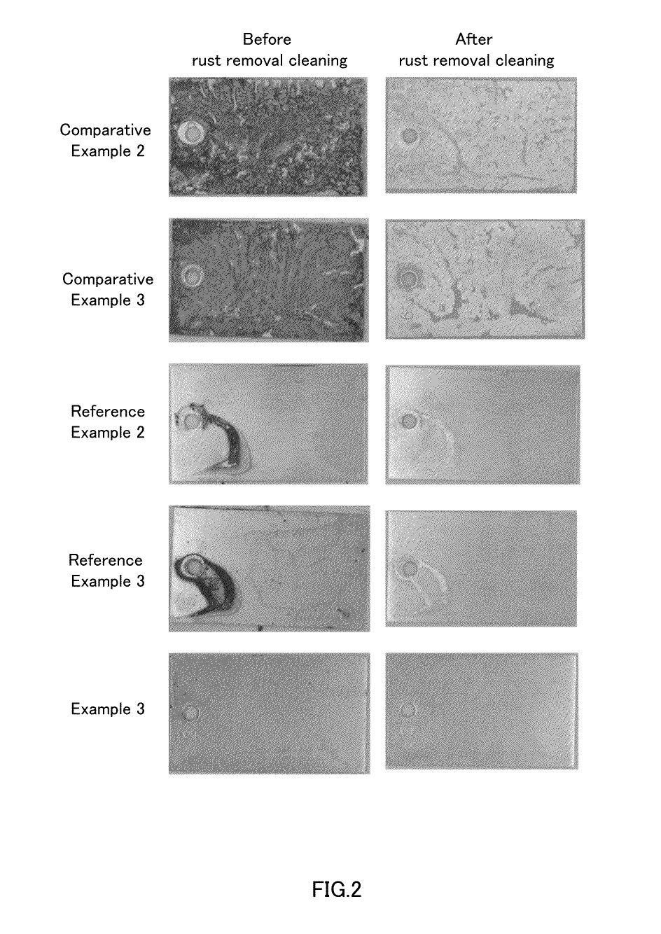

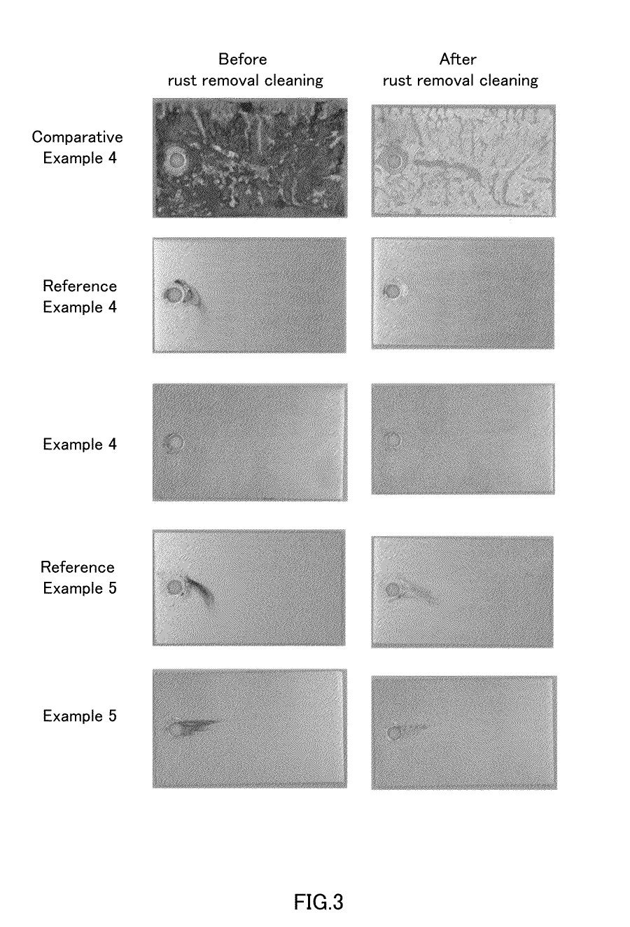

The test piece was collected after test. Red rust formed on the test piece was removed by a 15% hydrochloric acid aqueous solution and tap water, and the corrosion speed (MDD) was calculated from a difference in weight of the test piece before and after test, using the following formula. Tables 2 to 4 below show the results. FIGS. 1 to 3 are photographs showing the states before and after rust cleaning after test.

$$MDD = \frac{( \begin{matrix}Weight before test ( g ) - \\ Weight after rust removal cleaning ( g )\end{matrix} ) \times 1 , 000}{Surface area ( {dm}^{2} ) \times Test period ( days )}$$

TABLE 2

| | | Quaternary | Organic | Other insecticidal | | |
|---|---|---|---|---|---|---|
| | IPBC | ammonium | solvent | components | Condition | MDD |
| Comparative | — | — | — | — | Normal | 77.0 |
| Example 1 | | | | | temperature, | |
| | | | | | 5 days | |
| Reference | — | DMPAP | — | — | Normal | 6.8 |
| Example 1 | | 4000 ppm | | | temperature, | |
| | | | | | 5 days | |
| Reference | — | DMPAP | — | Cyproconazole 120 ppm | Normal | 7.2 |
| Examples | | 4000 ppm | | | temperature, | |
| 1-2 | | | | | 5 days | |
| Example 1 | 200 ppm | DMPAP | MDG | Imidacloprid 60 ppm | Normal | 0.4 |
| | | 4000 ppm | 3000 ppm | | temperature, | |
| | | | | | 5 days | |
| Example 2 | 200 ppm | DMPAP | MDG | Imidacloprid 60 ppm | Normal | 1.7 |
| | | 4000 ppm | 3000 ppm | Cyproconazole 120 ppm | temperature, | |
| | | | | | 5 days | |

TABLE 3

| | | Quaternary | Organic | Other insecticidal | | |
|---|---|---|---|---|---|---|
| | IPBC | ammonium | solvent | components | Condition | MDD |
| Comparative | — | — | — | — | 50° C., 48 h | 191.8 |
| Example 2 | | | | | | |
| Comparative | — | — | MDG | — | 50° C., 48 h | 245.9 |
| Example 3 | | | 3000 ppm | | | |
| Reference | — | DMPAP | MDG | — | 50° C., 48 h | 16.7 |
| Example 2 | | 2000 ppm | 3000 ppm | | | |
| Reference | — | DMPAP | MDG | Imidacloprid 60 ppm | 50° C., 48 h | 41.4 |
| Example 3 | | 2000 ppm | 3000 ppm | | | |
| Example 3 | 200 ppm | DMPAP | MDG | — | 50° C., 48 h | 10.5 |
| | | 2000 ppm | 3000 ppm | | | |

TABLE 4

| | | Quaternary | Organic | Other insecticidal | | |
|---|---|---|---|---|---|---|
| | IPBC | ammonium | solvent | components | Condition | MDD |
| Comparative | — | — | — | — | 50° C., 48 h | 94.5 |
| Example 4 | | | | | | |
| Reference | — | DMPAP | — | — | 50° C., 48 h | 3.8 |
| Example 4 | | 2000 ppm | | | | |
| Example 4 | 100 ppm | DMPAP | — | — | 50° C., 48 h | 2.3 |
| | | 2000 ppm | | | | |
| Reference | — | DDAA | — | — | 50° C., 48 h | 4.2 |
| Example 5 | | 2800 ppm | | | | |
| Example 5 | 100 ppm | DDAA | — | — | 50° C., 48 h | 0.8 |
| | | 2800 ppm | | | | |

As shown in Tables 2 to 4, the examples in which IPBC and the organic acid salt of quaternary ammonium were used in combination improved iron corrosion resistance than the comparative examples and the reference examples containing the organic acid salt of quaternary ammonium and not containing IPBC. Further, as shown in Tables 1 to 3, significant corrosion (partial corrosion) was observed around the hole portion in Reference Examples 1 to 5, whereas corrosion around the hole portion was effectively inhibited in Examples 1 to 4. The effect of inhibiting partial corrosion around the hole portion in Examples 1 to 4 was superior to that in Example 5.

1. A method for preventing corrosion of iron in a wood treatment device, comprising impregnating wood with a drug composition using the treatment device,
wherein the treatment device has a component or a portion made of iron that comes into contact with the drug composition, and
the drug composition is an aqueous solution composition containing an iodopropynyl carbamate compound and an organic acid salt of quaternary ammonium.

2. The method according to claim 1, wherein the treatment device is a pressure treatment device comprising a pressure-resistant pressure vessel and a pressurizing pump for injecting by pressure a drug composition into wood in the pressure vessel.

3. The method according to claim 1, wherein the treatment device is a pressure treatment device comprising a pressure-resistant pressure vessel, a liquid tank that can store a drug composition, and a pressurizing pump for injecting by pressure the drug composition in the liquid tank into the pressure vessel.

4. A method for treating wood with a pressure treatment device comprising a pressure-resistant pressure vessel and a pressurizing pump for injecting by pressure a drug composition into wood in the pressure vessel,
the method comprising bringing the drug composition into contact with wood in the pressure vessel,
wherein the pressure vessel has a component or a portion made of iron that comes into contact with the drug composition, and
the drug composition is an aqueous solution composition containing an iodopropynyl carbamate compound and an organic acid salt of quaternary ammonium.

5. A method for treating wood with a pressure treatment device comprising a pressure-resistant pressure vessel, a liquid tank that can store a drug composition, and a pressurizing pump for injecting by pressure the drug composition in the liquid tank into the pressure vessel,
the method comprising bringing the drug composition injected by pressure into contact with wood in the pressure vessel,
wherein the pressure vessel has a component or a portion made of iron that comes into contact with the drug composition, and
the drug composition is an aqueous solution composition containing an iodopropynyl carbamate compound and an organic acid salt of quaternary ammonium.

6. The method according to claim 1, wherein the iodopropynyl carbamate compound is expressed by the following general formula (I): 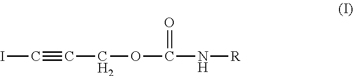
(where, in the general formula (I), R is selected from the group consisting of hydrogen, substituted and unsubstituted alkyl groups with 1 to 20 carbons, substituted and unsubstituted aryl, alkylaryl and aralkyl groups with 6 to 20 carbons, and substituted and unsubstituted cycloalkyl and cycloalkenyl groups with 3 to 10 carbons).

7. The method according to claim 1, wherein the iodopropynyl carbamate compound is 3-iodo-2-propynyl-n-butylcarbamate [IPBC].

8. The method according to claim 1, wherein the organic acid salt of quaternary ammonium is expressed by the following general formula (II): 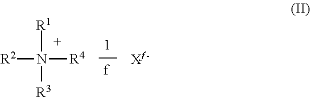
(where, in the general formula (II), R¹, R², and R³ represent the same or different alkyl groups with 1 to 24 carbons or alkenyl groups with 2 to 24 carbons; R⁴ is a polyoxyalkylene group with an average addition mole number of 1 to 20, an alkyl or alkenyl group with 6 to 24 carbons, or an arylalkyl or arylalkenyl group with 7 to 24 carbons; f is an integer of 1 to 10; and X^{f-} is an f-valent organic acid ion).

9. The method according to claim 1, wherein the quaternary ammonium is N,N-didecyl-N-methyl-poly(oxyethyl) ammonium.

10. The method according to claim 1, wherein the organic acid salt is a salt of an organic acid selected from oxalic acid, citric acid, malic acid, maleic acid, itaconic acid, tartaric acid, glutaric acid, adipic acid, pimelic acid, succinic acid, malonic acid, fumaric acid, phthalic acid, isophthalic acid, terephthalic acid, sebacic acid, azelaic acid, formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexane acid, 2-ethylhexane acid, n-octanoic acid, nonanoic acid, dodecanoic acid, tetradecanoic acid, stearic acid, oleic acid, benzoic acid, ethylbenzoic acid, cinnamic acid, t-butylbenzoic acid, glycolic acid, butanetetracarboxylic acid, trimellitic acid, pyromellitic acid, salicylic acid, glyceric acid, and lactic acid.

11. The method according to claim 1, wherein the drug composition further contains at least one of α-(4-chlorophenyl)-α-(1-cyclopropyl-ethyl)-1H-1,2,4-triazole-1-ethanol “cyproconazole”, and 1-(6-chloro-3-pyridinyl)-methyl.-4,5-dihydro-N-nitro-1H-imidazole-2-amine “imidacloprid”.

12. The method according to claim 1, wherein the drug composition further contains a hydrophilic organic solvent selected from the group consisting of ethylene glycol, diethylene glycol, polyethylene glycol, diethylene glycol monomethyl ether, propylene glycol, butyl diglycol, butyl glycol, methylpropylene glycol, 2-butoxyethanol, diethylene glycol monobutyl ether, isobutanol, sec-butanol, 2-ethyl-1-butanol, isopentanol, 1-heptanol, 1-octanol, neopentyl alcohol, and combinations of two or more of these.

13. The method according to claim 4, wherein the iodopropynyl carbamate compound is expressed by the following general formula (I): 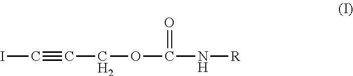
(where, in the general formula (I), R is selected from the group consisting of hydrogen, substituted and unsubstituted alkyl groups with 1 to 20 carbons, substituted and unsubstituted aryl, alkylaryl and aralkyl groups with 6 to 20 carbons, and substituted and unsubstituted cycloalkyl and cycloalkenyl groups with 3 to 10 carbons).

14. The method according to claim 4, wherein the organic acid salt of quaternary ammonium is expressed by the following general formula (II): 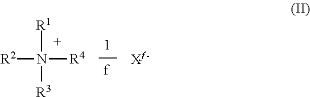
(where, in the general formula (II), R¹, R², and R³ represent the same or different alkyl groups with 1 to 24 carbons or alkenyl groups with 2 to 24 carbons; R⁴ is a polyoxyalkylene group with an average addition mole number of 1 to 20, an alkyl or alkenyl group with 6 to 24 carbons, or an arylalkyl or arylalkenyl group with 7 to 24 carbons; f is an integer of 1 to 10; and X^{f-} is an f-valent organic acid ion).

15. The method according to claim 4, wherein the drug composition further contains at least one of α-(4-chlorophenyl)-α-(1-cyclopropyl-ethyl)-1H-1,2,4-triazole-1-ethanol “cyproconazole”, and 1-(6-chloro-3-pyridinyl)-methyl.-4,5-dihydro-N-nitro-1H-imidazole-2-amine “imidacloprid”.

16. The method according to claim 4, wherein the drug composition further contains a hydrophilic organic solvent selected from the group consisting of ethylene glycol, diethylene glycol, polyethylene glycol, diethylene glycol monomethyl ether, propylene glycol, butyl diglycol, butyl glycol, methylpropylene glycol, 2-butoxyethanol, diethylene glycol monobutyl ether, isobutanol, sec-butanol, 2-ethyl-1-butanol, isopentanol, 1-heptanol, 1-octanol, neopentyl alcohol, and combinations of two or more of these.

17. The method according to claim 5, wherein the iodopropynyl carbamate compound is expressed by the following general formula (I): 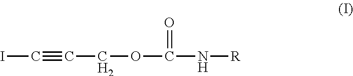
(where, in the general formula (I), R is selected from the group consisting of hydrogen, substituted and unsubstituted alkyl groups with 1 to 20 carbons, substituted and unsubstituted aryl, alkylaryl and aralkyl groups with 6 to 20 carbons, and substituted and unsubstituted cycloalkyl and cycloalkenyl groups with 3 to 10 carbons).

18. The method according to claim 5, wherein the organic acid salt of quaternary ammonium is expressed by the following general formula (II): 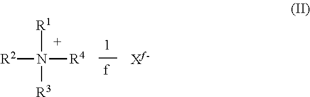
(where, in the general formula (II), R¹, R², and R³ represent the same or different alkyl groups with 1 to 24 carbons or alkenyl groups with 2 to 24 carbons; R⁴ is a polyoxyalkylene group with an average addition mole number of 1 to 20, an alkyl or alkenyl group with 6 to 24 carbons, or an arylalkyl or arylalkenyl group with 7 to 24 carbons; f is an integer of 1 to 10; and X^{f-} is an f-valent organic acid ion).

19. The method according to claim 5, wherein the drug composition further contains at least one of α-(4-chlorophenyl)-α-(1-cyclopropyl-ethyl)-1H-1,2,4-triazole-1-ethanol “cyproconazole”, and 1-(6-chloro-3-pyridinyl)-methyl.-4,5-dihydro-N-nitro-1H-imidazole-2-amine “imidacloprid”.

20. The method according to claim 5, wherein the drug composition further contains a hydrophilic organic solvent selected from the group consisting of ethylene glycol, diethylene glycol, polyethylene glycol, diethylene glycol monomethyl ether, propylene glycol, butyl diglycol, butyl glycol, methylpropylene glycol, 2-butoxyethanol, diethylene glycol monobutyl ether, isobutanol, sec-butanol, 2-ethyl-1-butanol, isopentanol, 1-heptanol, 1-octanol, neopentyl alcohol, and combinations of two or more of these.
